(19) United States
(12) Patent Application Publication
(10) Pub. No.: US 2026/0277157 A1
(43) Pub. Date: Sep. 17, 2026

(54) BARREL COMPLETE, MOVEMENT, AND TIMEPIECE

(71) Applicant: SEIKO EPSON CORPORATION, Tokyo (JP)

(72) Inventor: Hikaru SHIMOOKI, SHIOJIRI-SHI (JP)

(21) Appl. No.: 19/563,949

(22) Filed: Mar. 11, 2026

(30) Foreign Application Priority Data
Mar. 13, 2025 (JP) 2025-040055

(51) Int. Cl. G04B 1/16

(52) U.S. Cl. CPC G04B 1/16

(57) ABSTRACT

A barrel complete that rotates using a mainspring as a power source includes a barrel arbor having a rotary axis, a barrel accommodating the mainspring, and a barrel lid attached to the barrel and forming an accommodation space in which the mainspring is accommodated. The barrel lid has a flat surface portion extending along a first direction intersecting an axial direction along the rotary axis, and a side surface portion extending from an end portion of the flat surface portion along a second direction intersecting the first direction. The side surface portion has a second engaging portion that fixes the barrel lid to the barrel by being engaged with a first engaging portion formed on the barrel. A first groove that relieves stress is formed on the side surface portion.

### CROSS-REFERENCE TO RELATED APPLICATIONS

The present application is based on, and claims priority from JP Application Serial Number 2025-040055, filed Mar. 13, 2025, the disclosure of which is hereby incorporated by reference herein in its entirety.

### BACKGROUND OF THE INVENTION

### 1. Technical Field

The present disclosure relates to a barrel complete, a movement, and a timepiece.

### 2. Related Art

JP-A-11-174162 discloses a configuration of a barrel complete in which a mainspring is accommodated in a space formed by fitting an outer peripheral wall of a barrel lid having a pawl to an outer peripheral wall of a barrel gear. When the barrel lid is fitted to the outer peripheral wall of the barrel gear, the barrel lid is expanded so as to allow the pawl to be pushed away, and therefore, the barrel lid may be deformed. When the barrel lid is deformed, the barrel lid comes into contact with a component close to the barrel complete. Therefore, in order to prevent a deformation of the barrel lid, the thickness of the barrel lid may be increased.

However, in the configuration of the related art, when the thickness of the barrel lid is increased, the thickness of the barrel complete is increased, and thus, there is a problem in that the movement and further the timepiece are increased in size.

### SUMMARY OF THE INVENTION

A barrel complete of the present disclosure rotates using a mainspring as a power source, and includes a barrel arbor having a rotary axis, a barrel accommodating the mainspring, and a barrel lid attached to the barrel and forming an accommodation space in which the mainspring is accommodated. The barrel lid has a flat surface portion that extends along a first direction intersecting an axial direction along the rotary axis, and a side surface portion that extends from an end portion of the flat surface portion along a second direction intersecting the first direction. The side surface portion has a second engaging portion that fixes the barrel lid to the barrel by being engaged with a first engaging portion formed on the barrel, and a first groove that relieves stress is formed on the side surface portion.

A movement of the present disclosure includes the barrel complete described above, a train wheel driven by the barrel complete, a main plate on which the barrel complete is disposed, and a train wheel bridge that supports the barrel complete and the train wheel together with the main plate.

A timepiece of the present disclosure includes the movement described above and a case that accommodates the movement.

### BRIEF DESCRIPTION OF DRAWINGS

FIG. 1 is a plan view showing a configuration of a timepiece on a dial side.

FIG. 2 is a plan view showing a configuration of the timepiece on a case back side.

FIG. 3 is a plan view showing a configuration of a movement on the dial side.

FIG. 4 is a plan view showing a configuration of the movement on the case back side.

FIG. 5 is a cross-sectional view showing a configuration of a main portion of the movement.

FIG. 6 is a cross-sectional view showing a configuration of a main portion of the movement.

FIG. 7 is a cross-sectional view showing a configuration of a main portion of the movement.

FIG. 8 is a perspective view showing a configuration of a main portion of the movement.

FIG. 9 is a perspective view showing a configuration of a main portion of the movement.

FIG. 10 is a cross-sectional view showing a configuration of a barrel complete of the present embodiment.

FIG. 11 is a cross-sectional view showing a configuration of the barrel complete of Modification Example 1.

FIG. 12 is a cross-sectional view showing a configuration of the barrel complete of Modification Example 2.

FIG. 13 is a cross-sectional view showing a configuration of the barrel complete of Modification Example 3.

FIG. 14 is a cross-sectional view showing a configuration of the barrel complete of Modification Example 4.

FIG. 15 is a cross-sectional view showing a configuration of the barrel complete of Modification Example 5.

FIG. 16 is a cross-sectional view showing a configuration of the barrel complete of Modification Example 6.

FIG. 17 is a cross-sectional view showing a configuration of the barrel complete of Modification Example 7.

FIG. 18 is a cross-sectional view showing a configuration of the barrel complete of Modification Example 8.

FIG. 19A is a cross-sectional view showing a configuration of a barrel complete in the related art.

FIG. 19B is a cross-sectional view showing a configuration of a barrel lid in the related art.

### DETAILED DESCRIPTION OF THE INVENTION

Hereinafter, configurations of a barrel complete 1000, a movement 10, and a timepiece 1 will be described with reference to the drawings. In each of the following drawings, a plan view means a state viewed from a direction along a first barrel arbor 23 and a second barrel arbor 33 described later, that is, a direction orthogonal to a dial 3, and a cross-sectional view means a state viewed from a direction perpendicular to the first barrel arbor 23 and the second barrel arbor 33.

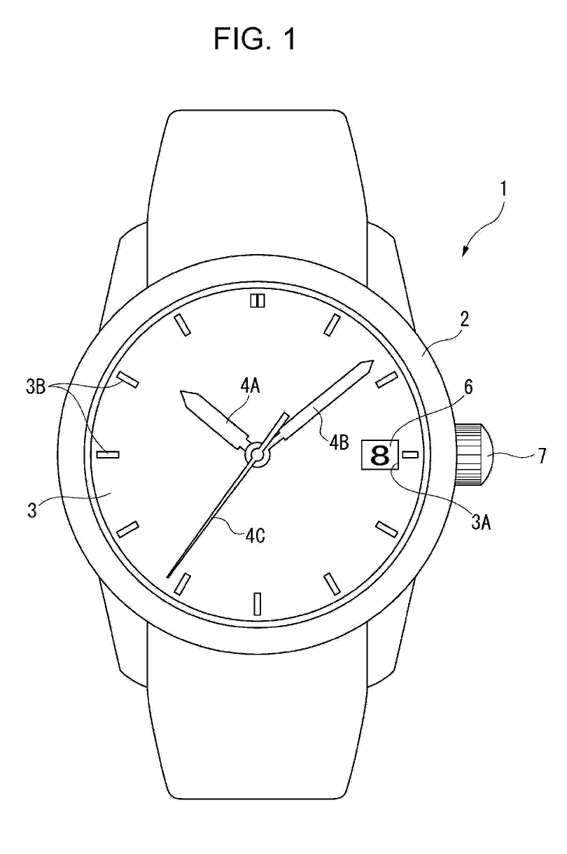

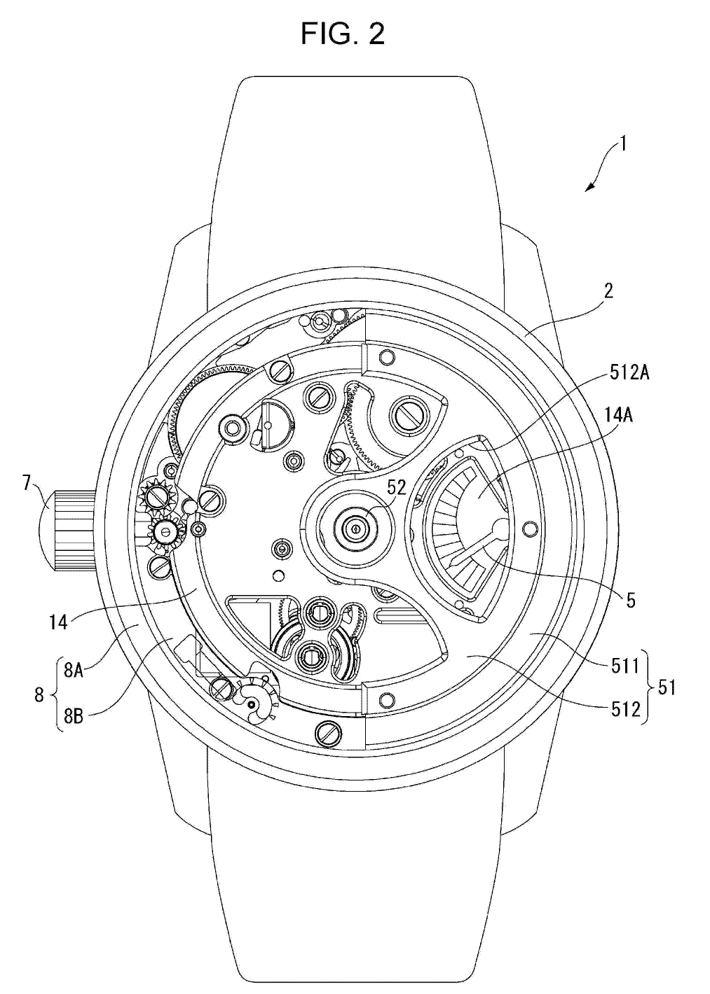

First, the configuration of the timepiece 1 will be described with reference to FIGS. 1 and 2.

As shown in FIGS. 1 and 2, the timepiece 1 is a wristwatch worn on the wrist of a user, and includes an outer case 2 as a case having a cylindrical shape, and a dial 3 is disposed on an inner peripheral side of the outer case 2. The timepiece 1 of the present embodiment is a skeleton type timepiece in which a power reserve hand 5 can be visually recognized from a rear surface side of the timepiece 1.

The timepiece 1 is a wristwatch worn on the wrist of a user, and includes the outer case 2 having the cylindrical shape, and has the dial 3 disposed on the inner peripheral side of the outer case 2. Of the two openings of the outer case 2, the opening on the front surface side is closed by a cover glass, and the opening on the rear surface side is closed by a case back 8. The case back 8 is composed of a ring-shaped frame 8A and a case back glass 8B attached to the frame 8A.

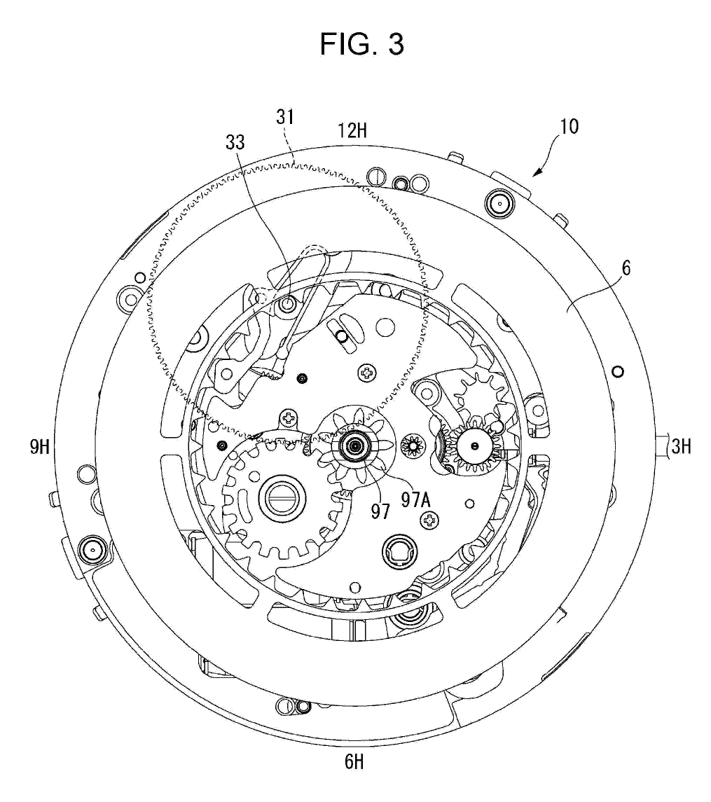

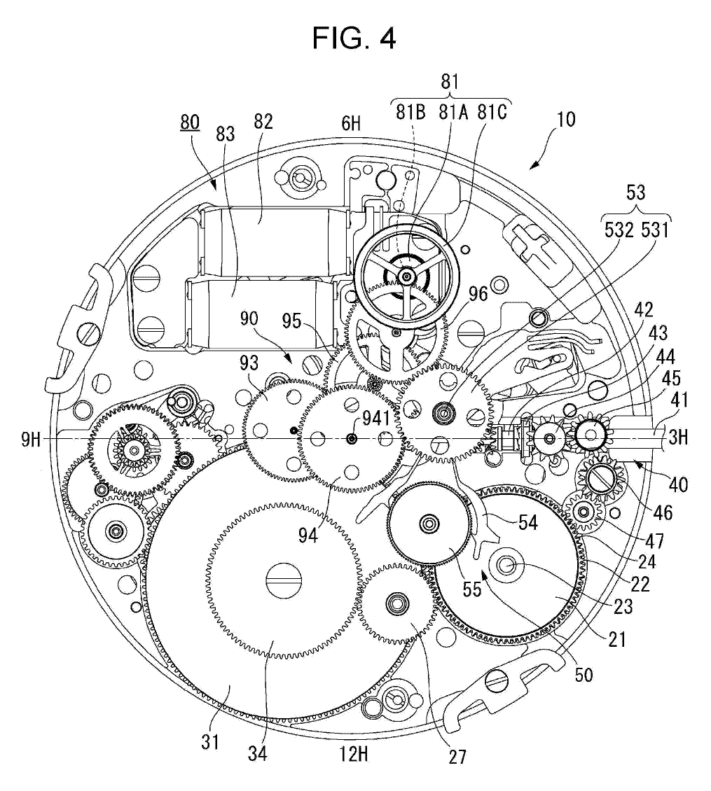

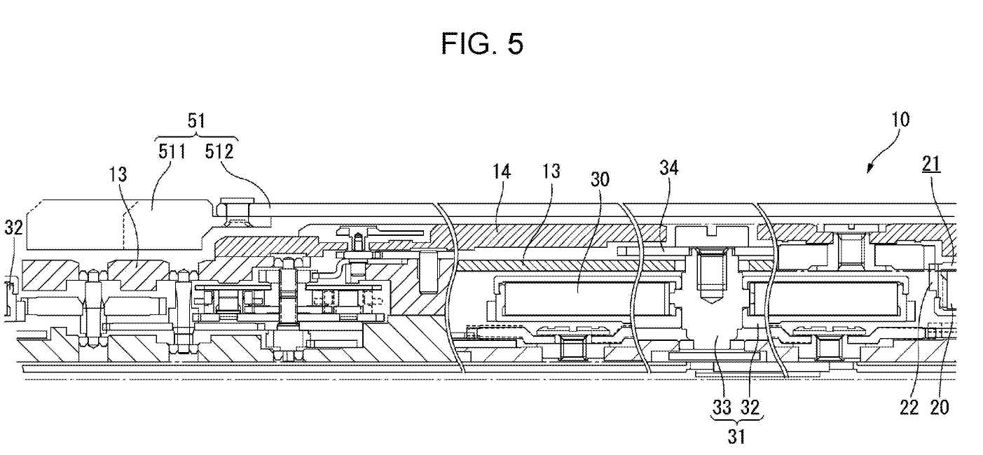

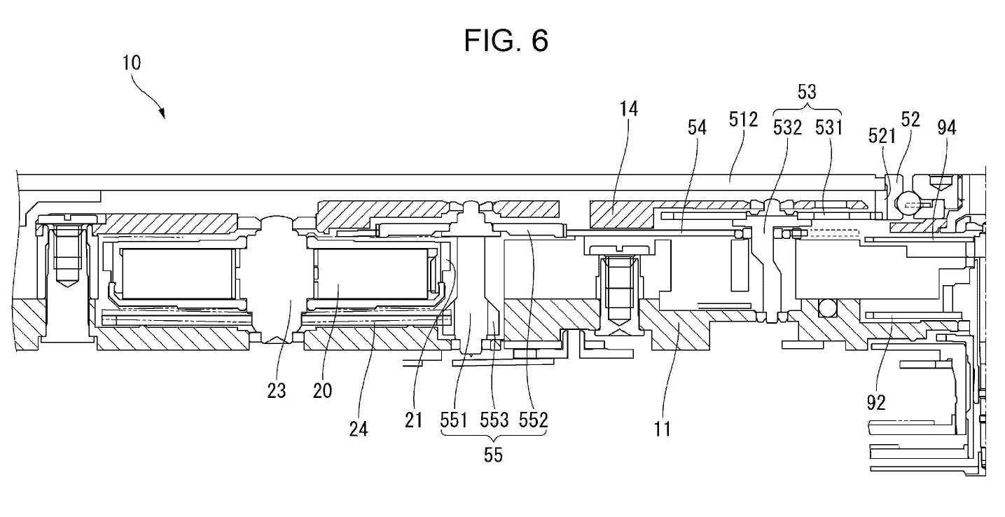

The timepiece 1 includes the movement 10 (see FIGS. 3 and 4) accommodated in the outer case 2, an hour hand 4A, a minute hand 4B, and a second hand 4C that indicate time information, and the power reserve hand 5 that indicates a winding remaining amount of mainsprings 20 and 30 (see FIGS. 5 and 6).

The dial 3 is provided with a calendar small window 3A, and a date indicator 6 can be visually recognized from the calendar small window 3A. In addition, an hour mark 3B for indicating the time is provided on the dial 3.

As shown in FIG. 2, an opening 512A is formed in a weight body 512 of a rotary weight 51 so that the power reserve hand 5 is less likely to be invisible depending on the position of the rotary weight 51. A fan-shaped scale portion 14A is provided on the rear surface of a train wheel bridge 14. The winding remaining amount of the mainsprings 20 and 30 can be displayed by the power reserve hand 5 indicating the scale portion 14A.

A crown 7 is provided on a side surface of the outer case 2. The crown 7 can be pulled and moved from a 0-stage position pushed in toward the center of the timepiece 1 to a 1-stage position and a 2-stage position.

When the crown 7 is rotated at the 0-stage position, the mainsprings 20 and 30 provided in the movement 10 can be wound. The power reserve hand 5 moves in conjunction with the winding of the mainsprings 20 and 30.

When the crown 7 is pulled to the 1-stage position and rotated, the date indicator 6 is moved and the date can be set. When the crown 7 is pulled to the 2-stage position, the second hand 4C stops, and when the crown 7 is rotated at the 2-stage position, the hour hand 4A and the minute hand 4B are moved and the time can be set.

Next, the configuration of the movement 10 will be described with reference to FIGS. 3-9.

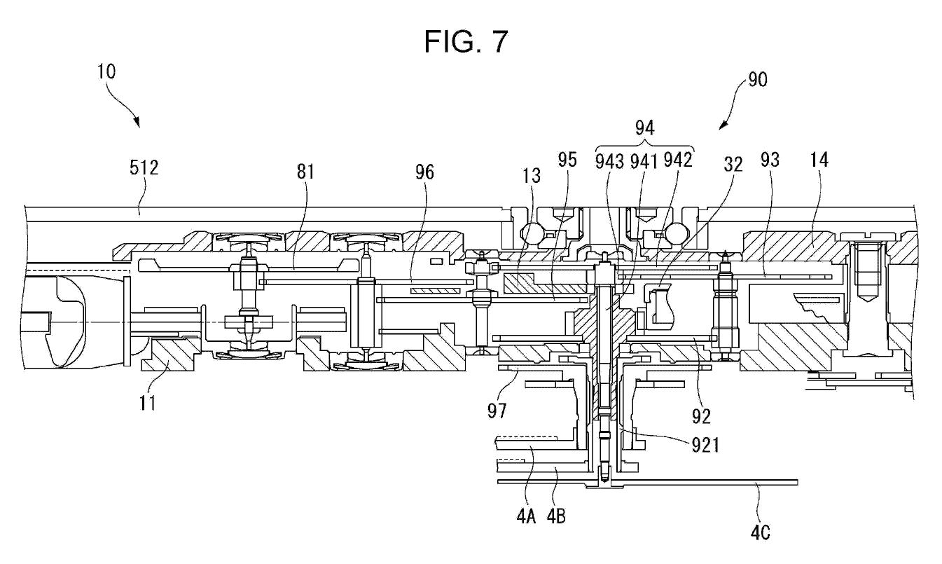

As shown in FIGS. 3-9, the movement 10 includes a first barrel complete 21 in which the first mainspring 20 is accommodated, and a second barrel complete 31 in which the second mainspring 30 is accommodated. The hour hand 4A, the minute hand 4B, and the second hand 4C (see FIG. 1) are respectively attached to an hour wheel 97 (see FIG. 3), a cannon pinion 921 (see FIG. 7), and a second hand shaft 941 (see FIGS. 4 and 7) of the movement 10, and are driven by the first mainspring 20 and the second mainspring 30 of the movement 10.

The movement 10 includes a main plate 11 (see FIGS. 6 and 7), a center wheel bridge 13 (see FIG. 7), and the train wheel bridge 14 (see FIGS. 5-7).

As shown in FIGS. 5 and 6, between the main plate 11 and the train wheel bridge 14, there are arranged the first barrel complete 21 in which the first mainspring 20 is accommodated, the second barrel complete 31 in which the second mainspring 30 is accommodated, and a manual winding mechanism 40 and an automatic winding mechanism 50 (see FIG. 4) which wind the first mainspring 20 and the second mainspring 30.

Between the main plate 11, the center wheel bridge 13, and the train wheel bridge 14, there are arranged a power reserve display mechanism which displays a winding remaining amount of the mainsprings 20 and 30, a display train wheel 90 (see FIG. 7) as a train wheel which transmits a torque of the mainsprings 20 and 30, and a generator 80 (see FIG. 4) driven by a torque transmitted via the display train wheel 90.

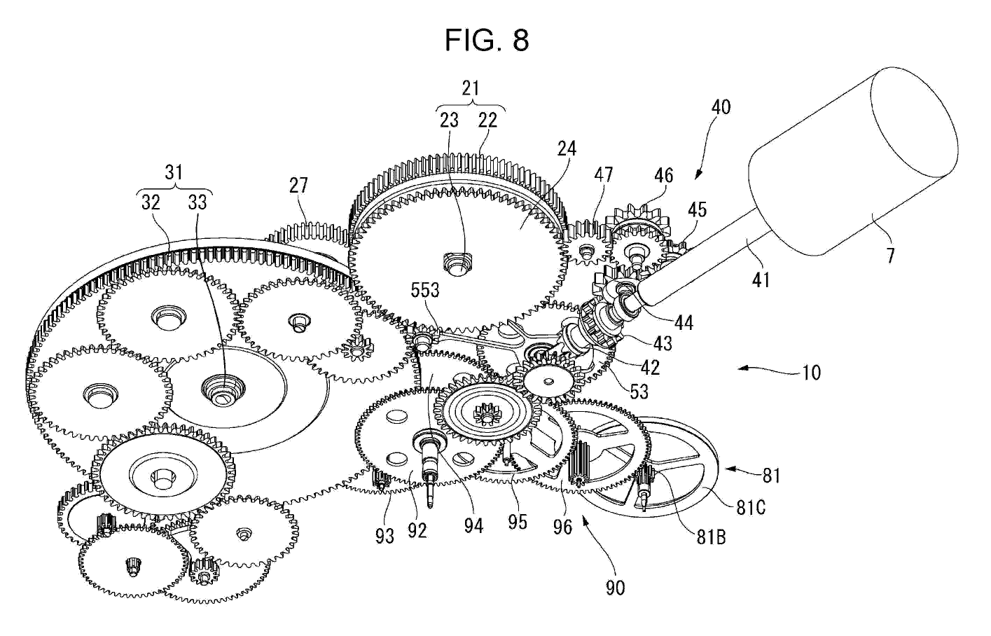

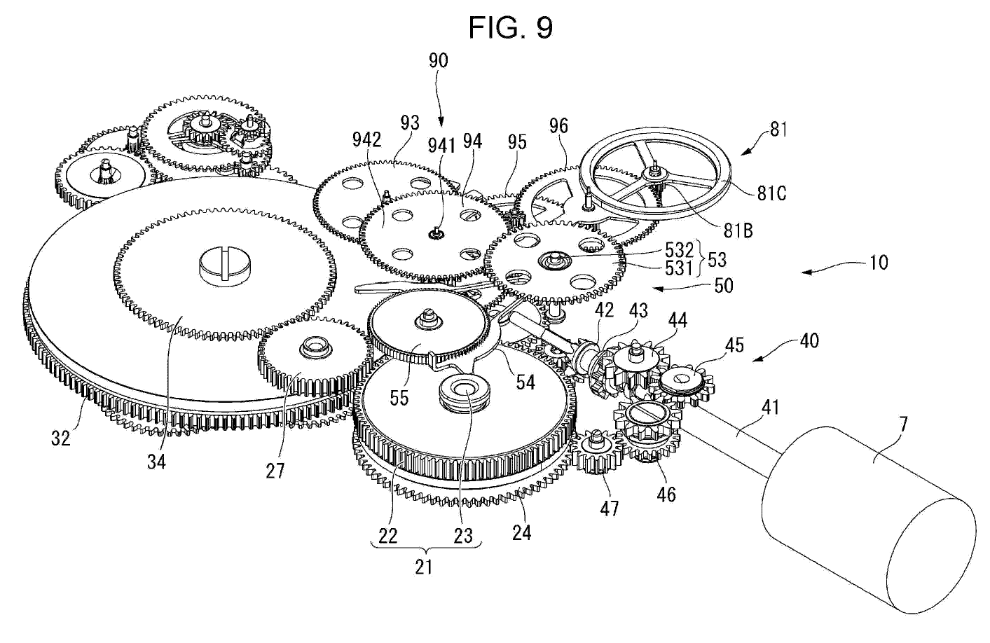

Next, the configurations of the first mainspring 20 and the first barrel complete 21 will be described with reference to FIGS. 8 and 9.

The first barrel complete 21 includes the first mainspring 20, a first barrel 22, and a first barrel arbor 23. As shown in FIG. 8, a first ratchet wheel 24 which rotates integrally with the first barrel arbor 23 is attached to the first barrel arbor 23.

Next, the configuration of the manual winding mechanism 40 will be described with reference to FIGS. 4 and 8.

As shown in FIGS. 4 and 8, the manual winding mechanism 40 includes a winding stem 41 to which the crown 7 is attached, a winding wheel 42, a winding pinion 43, a crown wheel 44, a ratchet first transmission wheel 45, a ratchet second transmission wheel 46, and a ratchet third transmission wheel 47. The ratchet third transmission wheel 47 meshes with the first ratchet wheel 24.

When the user rotationally operates the crown 7 at the 0-stage position, the winding stem 41 and the winding wheel 42 rotate. When the crown 7 is at the 0-stage position, the winding wheel 42 meshes with the winding pinion 43, and the rotation of the winding wheel 42 is sequentially transmitted from the winding pinion 43 to the crown wheel 44, the ratchet first transmission wheel 45, the ratchet second transmission wheel 46, and the ratchet third transmission wheel 47. Therefore, the first ratchet wheel 24 and the first barrel arbor 23 rotate, and the first mainspring 20 is wound.

The ratchet second transmission wheel 46 is a wheel with a slotted screw, and the first mainspring 20 can be wound by inserting a slotted screwdriver or the like into the slotted screw and rotating the ratchet second transmission wheel 46. Therefore, the first mainspring 20 can be wound at the time of assembling the movement 10, and such a structure does not impair convenience even if a ratchet screw is not arranged.

Next, the configuration of the automatic winding mechanism 50 will be described with reference to FIGS. 2 and 4-6.

As shown in FIGS. 2 and 4-6, the automatic winding mechanism 50 includes the rotary weight 51, a bearing 52, an eccentric wheel 53 that meshes with a rotary weight gear 521 of an outer ring of the bearing 52, a pawl lever 54, and a transmission wheel 55.

The rotary weight 51 includes a weight 511 and a weight body 512. The bearing 52 rotatably supports the rotary weight 51, and includes, on the outer ring, the rotary weight gear 521 which rotates integrally with the rotary weight 51.

As shown in FIG. 6, the eccentric wheel 53 includes an eccentric shaft member 532 and an eccentric gear 531. The eccentric shaft member 532 is axially supported by the main plate 11 and the train wheel bridge 14. Further, the eccentric shaft member 532 includes an eccentric shaft portion provided eccentrically from a rotary axis. The eccentric gear 531 meshes with the rotary weight gear 521 of the bearing 52. As a result, the eccentric wheel 53 rotates in both forward and reverse directions in conjunction with the rotary weight 51.

As shown in FIGS. 4 and 6, the pawl lever 54 is rotatably attached to the eccentric shaft portion of the eccentric shaft member 532 of the eccentric wheel 53. When the eccentric wheel 53 rotates in conjunction with the rotary weight 51, the pawl lever 54 attached to the eccentric wheel 53 moves forward and backward in a direction approaching the transmission wheel 55 and in a direction away from the transmission wheel 55, thereby rotating the transmission wheel 55 in one direction.

As shown in FIG. 6, the transmission wheel 55 includes a transmission wheel shaft 551, a first transmission gear 552, and a second transmission gear 553. The transmission wheel shaft 551 is axially supported by the main plate 11 and the train wheel bridge 14. The pawl lever 54 is engaged with the first transmission gear 552, and the transmission wheel 55 rotates in one direction in conjunction with the forward and backward movement of the pawl lever 54. The second transmission gear 553 meshes with the first ratchet wheel 24.

Accordingly, the first ratchet wheel 24 rotates in conjunction with the rotation of the transmission wheel 55. When the first ratchet wheel 24 rotates, the first barrel arbor 23 rotates integrally with the first ratchet wheel 24, and the first mainspring 20 is wound. Therefore, the timepiece 1 of the present embodiment can wind the first mainspring 20 by both manual winding by operating the crown 7 and automatic winding by rotating the rotary weight 51. The transmission wheel 55 is a winding wheel that meshes with the first ratchet wheel 24 in the automatic winding mechanism 50.

Next, the configurations of the second mainspring 30 and the second barrel complete 31 will be described with reference to FIGS. 4 and 5.

As shown in FIGS. 4 and 5, the second mainspring 30 is accommodated in the second barrel complete 31. The second barrel complete 31 includes a second barrel 32 and a second barrel arbor 33. The second barrel arbor 33 is rotatable integrally with a second ratchet wheel 34.

The second mainspring 30 is wound by the first mainspring 20. That is, when the first mainspring 20 is wound and torque capable of winding the second mainspring 30 is accumulated, the first barrel 22 of the first barrel complete 21 rotates. The first barrel 22 meshes with the second ratchet wheel 34 of the second barrel complete 31 via a barrel intermediate wheel 27, and when the first barrel 22 rotates, the second ratchet wheel 34 and the second barrel arbor 33 rotate, and the second mainspring 30 is wound.

Therefore, in the timepiece 1 of the present embodiment, the first mainspring 20 and the second mainspring 30 can be wound by either the manual winding mechanism 40 or the automatic winding mechanism 50. Note that the timepiece 1 may be provided with only one of the two winding mechanisms, the manual winding mechanism 40 or the automatic winding mechanism 50.

Next, the configuration of the generator 80 will be described with reference to FIG. 4.

As shown in FIG. 4, the generator 80 includes a rotor 81 and coil blocks 82 and 83. The rotor 81 includes a rotor magnet 81A, a rotor pinion 81B, and a rotor inertia disk 81C. The rotor inertia disk 81C reduces the variation in the number of rotations of the rotor 81 with respect to the variation in a driving torque from the second barrel 32. The coil blocks 82 and 83 are formed by winding a coil around each core.

Therefore, when the rotor 81 is rotated by external torque, the generator 80 generates induced power by the coil blocks 82 and 83, outputs electric energy, and can supply the electric energy to an IC or the like. In addition, a brake can be applied to the rotor 81 by short-circuiting the coil, and a rotation period of the rotor 81 can be adjusted to be constant by controlling a braking force.

Next, the display train wheel 90 will be described with reference to FIGS. 4, 7, 8, and 9.

As shown in FIGS. 4, 7, 8, and 9, the display train wheel 90 drives the hour hand 4A, the minute hand 4B, and the second hand 4C by mechanical energy from the first mainspring 20 and the second mainspring 30. The display train wheel 90 includes a center wheel and pinion 92, a third wheel and pinion 93, a fourth wheel and pinion 94, a fifth wheel and pinion 95, and a sixth wheel and pinion 96. After the rotation of the second barrel 32 is transmitted to the center wheel and pinion 92, the speed is sequentially increased in the order of the third wheel and pinion 93, the fourth wheel and pinion 94, the fifth wheel and pinion 95, and the sixth wheel and pinion 96, and the rotation is transmitted to the rotor 81.

The minute hand 4B is fixed to the center wheel and pinion 92 via the cannon pinion 921. The fourth wheel and pinion 94 includes the second hand shaft 941 to which the second hand 4C is fixed, a fourth gear 942 which meshes with the fifth wheel and pinion 95, and a fourth pinion 943 which meshes with the third wheel and pinion 93. In the present embodiment, the second hand shaft 941 of the fourth wheel and pinion 94 is axially supported by the train wheel bridge 14 and the main plate 11 via the cannon pinion 921. The hour wheel 97 is connected to the cannon pinion 921 via a minute wheel (not shown), and the hour hand 4A is fixed to the hour wheel 97.

Next, the configuration of the second barrel complete 31 as a barrel complete will be described with reference to FIG. 8. Hereinafter, the second barrel complete 31 will be described as a barrel complete 1000, the second mainspring 30 will be described as a mainspring 30, and the second barrel arbor 33 will be described as a barrel arbor 33.

The barrel complete 1000 is rotated using the mainspring 30 as a power source. The barrel complete 1000 includes the barrel arbor 33 having a rotary axis J, a barrel 100 accommodating the mainspring 30, and the barrel lid 200 attached to the barrel 100.

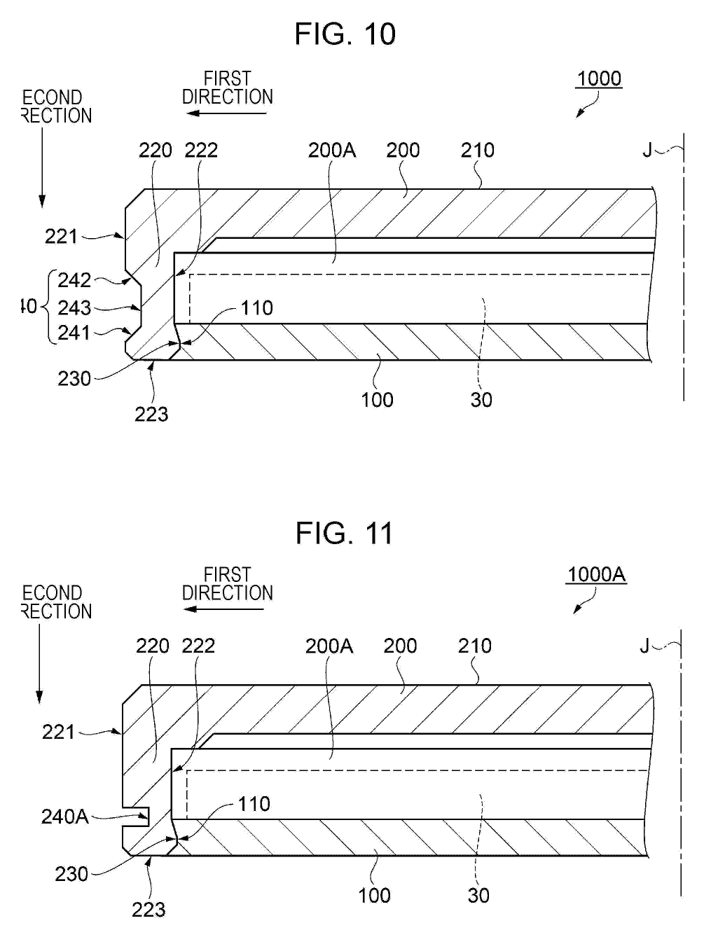

Specifically, as shown in FIG. 10, in the barrel complete 1000, an accommodation space 200A in which the mainspring 30 is accommodated is formed by the barrel 100 and the barrel lid 200 attached to the barrel 100.

The barrel lid 200 has a flat surface portion 210 that extends along a first direction intersecting an axiial direction along the rotary axis J. Further, the barrel lid 200 has a side surface portion 220 that extends from an end portion of the flat surface portion 210 along a second direction intersecting the first direction. In the present embodiment, the first direction is a direction orthogonal to the axial direction along the rotary axis J, and the second direction is a direction orthogonal to the first direction.

A first engaging portion 110 having a concave shape is formed on an end portion of the barrel 100. A second engaging portion 230 having a convex shape is formed on a distal end side of the side surface portion 220 of the barrel lid 200. The second engaging portion 230 functions as a pawl. That is, by engaging the second engaging portion 230 with the first engaging portion 110, the barrel lid 200 is fixed to the barrel 100.

Further, a first groove 240 that relieves stress is formed on the side surface portion 220. Specifically, the first groove 240 is provided over the entire circumference of the side surface portion 220. Further, the first groove 240 is provided in a direction perpendicular to the rotary axis J, that is, in a radial direction.

When a cross section of the side surface portion 220 is viewed from the first direction, for example, the shape of the first groove 240 has a first inclined portion 241 inclined toward a side of the flat surface portion 210 with respect to the outer surface 221 and extending toward a side of the inner surface 222, a second inclined portion 242 inclined toward a side opposite to the side of the flat surface portion 210 with respect to the outer surface 221 and extending toward the side of the inner surface 222, and a bottom portion 243 connecting the first inclined portion 241 and the second inclined portion 242. In other words, the first groove 240 has a trapezoidal shape when the cross section of the side surface portion 220 including the rotary axis J of the barrel arbor 33 is viewed.

Note that the first direction shown in FIG. 10 indicates from the right side to the left side of the paper surface, but as described above, the first direction is a direction intersecting the axial direction along the rotary axis J, and therefore, the view seen in FIG. 10 can also be a view seen from the first direction.

In this way, since the first groove 240 is formed on the side surface portion 220 of the barrel lid 200, when the barrel lid 200 is attached to the barrel 100 at the time of assembly and when the side surface portion 220 of the barrel lid 200 is expanded to engage the first engaging portion 110 and the second engaging portion 230 (see FIGS. 19A and 19B), the side surface portion 220 can be deformed corresponding to a force applied from a side of the inner surface 222 of the barrel lid 200, thereby enabling the first groove 240 to relieve the force applied to the side surface portion 220. Therefore, when the first engaging portion 110 and the second engaging portion 230 are engaged with each other, an expanded shape of the side surface portion 220 of the barrel lid 200 can be returned to an original shape, and warping of the barrel lid 200 can be suppressed. As a result, for example, it is not necessary to increase the thickness of the barrel lid 200 in order to increase a rigidity of the barrel lid 200, and it is possible to prevent the barrel complete 1000, the movement 10, and the timepiece 1 from becoming larger.

Since the shape of the first groove 240 is a trapezoidal shape, a part of the side surface portion 220 can be thinned, and the rigidity of the side surface portion 220 can be weakened, and the stress applied to the side surface portion 220 around the second engaging portion 230, specifically, the pressure applied from the inner surface 222 to the outer surface 221 in the side surface portion 220, can be relieved by deforming the thinned portion of the side surface portion 220. Therefore, when the first engaging portion 110 and the second engaging portion 230 are engaged with each other, the expanded shape of the side surface portion 220 of the barrel lid 200 can be returned to the original shape.

As described above, the barrel complete 1000 of the present embodiment rotates using the mainspring 30 as a power source, and includes the second barrel arbor 33 having the rotary axis J, the barrel 100 accommodating the mainspring 30, and the barrel lid 200 attached to the barrel 100 and forming the accommodation space 200A in which the mainspring 30 is accommodated. The barrel lid 200 has the flat surface portion 210 that extends along the first direction intersecting the axial direction along the rotary axis J, and the side surface portion 220 that extends from the end portion of the flat surface portion 210 along the second direction intersecting the first direction. The side surface portion 220 has the second engaging portion 230 that fixes the barrel lid 200 to the barrel 100 by being engaged with the first engaging portion 110 formed on the barrel 100, and the first groove 240 that relieves stress is formed on the side surface portion 220.

According to this configuration, since the first groove 240 is formed on the entire circumference of the side surface portion 220 of the barrel lid 200, specifically, the first groove 240 is formed in the vicinity of the second engaging portion 230, when the side surface portion 220 of the barrel lid 200 is expanded to engage the first engaging portion 110 and the second engaging portion 230 when attaching the barrel lid 200 to the barrel 100 at the time of assembly, the side surface portion 220 can be deformed corresponding to the force applied from the side of the inner surface 222 of the barrel lid 200, and the force applied to the side surface portion 220 can be relieved by the first groove 240. Therefore, when the first engaging portion 110 and the second engaging portion 230 are engaged with each other, the expanded shape of the side surface portion 220 of the barrel lid 200 can be returned to the original shape, and warping of the barrel lid 200 can be suppressed. As a result, for example, it is not necessary to increase the thickness of the barrel lid 200 in order to increase a rigidity of the barrel lid 200, and it is possible to prevent the barrel complete 1000, the movement 10, and the timepiece 1 from becoming larger.

In addition, it is also conceivable that an entire thickness of the side surface portion 220 of the barrel lid 200 is thinned, but by thinning the entire side surface portion 220, it becomes difficult to detach the barrel lid 200 at the time of repairing the timepiece 1, and there is a concern that the workability of the service after the sales is deteriorated. However, by providing the first groove 240 in a part of the side surface portion 220 as in the present embodiment, it is possible to suppress an occurrence of warping of the barrel complete 1000 while ensuring the workability of the service after the sales.

Further, in the barrel complete 1000 of the present embodiment, when the cross section of the side surface portion 220 is viewed from the first direction, the first groove 240 may have the first inclined portion 241 inclined toward a side of the flat surface portion 210 with respect to the outer surface 221 and extending toward a side of the inner surface 222, the second inclined portion 242 inclined toward a side opposite to the side of the flat surface portion 210 with respect to the outer surface 221 and extending toward the side of the inner surface 222, and the bottom portion 243 connecting the first inclined portion 241 and the second inclined portion 242. According to this configuration, since the first groove 240 has the first inclined portion 241, the second inclined portion 242, and the bottom portion 243, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by deforming the thinned portion of the side surface portion 220. Accordingly, when the first engaging portion 110 and the second engaging portion 230 are engaged with each other, the expanded shape of the side surface portion 220 of the barrel lid 200 can be returned to the original shape.

The movement 10 of the present embodiment includes the barrel complete 1000 described above, the display train wheel 90 driven by the barrel complete 1000, the main plate 11 on which the barrel complete 1000 is disposed, and the train wheel bridge 14 that supports the barrel complete 1000 and the display train wheel 90 together with the main plate 11. According to this configuration, since the above-described barrel complete 1000 is provided, it is possible to provide the movement 10 in which an increase in size is suppressed.

In addition, the timepiece 1 of the present embodiment includes the movement 10 described above and the outer case 2 which accommodates the movement 10. According to this configuration, since the above-described movement 10 is provided, it is possible to provide the timepiece 1 in which an increase in size is suppressed.

Hereinafter, modification examples of the above-described embodiment will be described.

As described above, the shape of the first groove 240 is not limited to the trapezoidal shape, and may be a shape as shown in FIG. 11. As shown in FIG. 11, in the barrel complete 1000A of Modified Example 1, the shape of the first groove 240A is a quadrangular shape when the cross section of the side surface portion 220 including the rotary axis J is viewed. Specifically, the first groove 240A is provided on the outer surface 221 of the side surface portion 220, and extends from the outer surface 221 toward the inner surface 222, that is, in the radial direction.

In this way, since the first groove 240A is provided on the outer surface 221 of the side surface portion 220 in the radial direction, a part of the side surface portion 220 can be thinned, and the rigidity of the side surface portion 220 can be weakened. Therefore, the stress applied to the side surface portion 220 around the second engaging portion 230, specifically, the pressure applied from the inner surface 222 to the outer surface 221 in the side surface portion 220, can be relieved by deforming a thinned side surface portion 220. Accordingly, when the first engaging portion 110 and the second engaging portion 230 are engaged with each other, the expanded shape of the side surface portion 220 of the barrel lid 200 can be returned to the original shape.

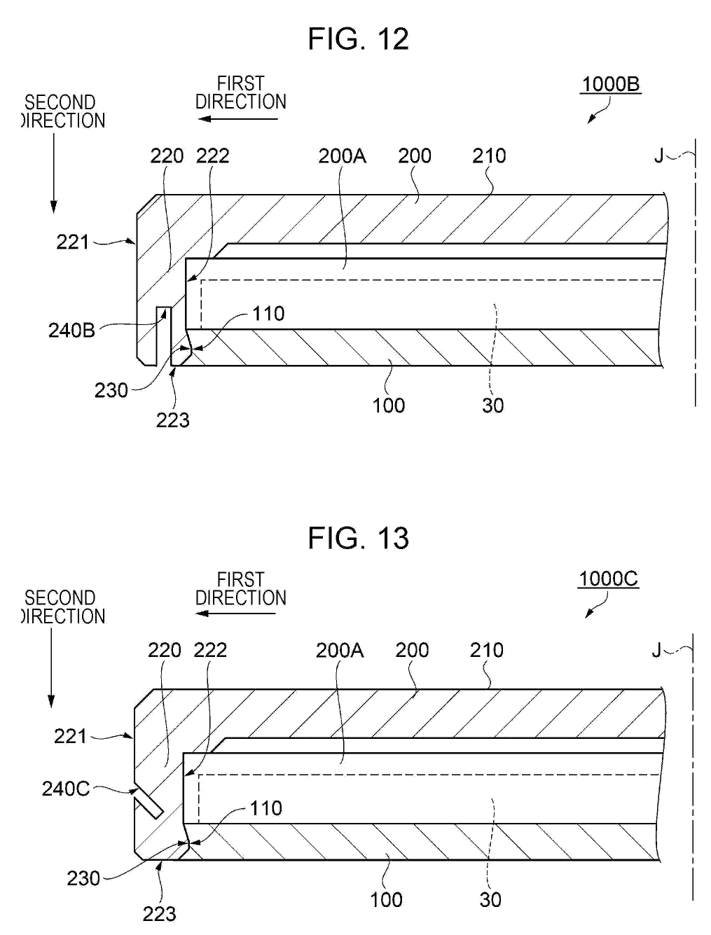

The shape of the first groove 240 may be a shape as shown in FIG. 12. As shown in FIG. 12, in the barrel complete 1000B of Modified Example 2, the shape of the first groove 240B is formed in a rectangular shape from the distal end surface 223 toward a thrust direction when the cross section of the side surface portion 220 including the rotary axis J is viewed. Specifically, the first groove 240B is provided on the distal end surface 223 of the side surface portion 220, and extends from the distal end surface 223 toward the flat surface portion 210 in parallel to the rotary axis J.

In this way, since the first groove 240B extends from the distal end surface 223 toward the flat surface portion 210, in other words, in the thrust direction, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by deforming a thinned side surface portion 220. Accordingly, when the first engaging portion 110 and the second engaging portion 230 are engaged with each other, the expanded shape of the side surface portion 220 of the barrel lid 200 can be returned to the original shape. In addition, since the first groove 240B is formed on a portion closer to the second engaging portion 230, it is possible to further relieve the stress applied to the side surface portion 220.

Further, the shape of the first groove 240 may be a shape as shown in FIG. 13. As shown in FIG. 13, in the barrel complete 1000C of Modified Example 3, the shape of the first groove 240C is formed in a rectangular shape obliquely downward from the outer surface 221 when the cross section of the side surface portion 220 including the rotary axis J is viewed. Specifically, the first groove 240C is inclined with respect to the outer surface 221 and extends toward a side opposite to the side of the flat surface portion 210.

In this way, since the first groove 240C is inclined and extends from the outer surface 221 toward the side opposite to the flat surface portion 210, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by deforming a thinned side surface portion 220. Accordingly, when the first engaging portion 110 and the second engaging portion 230 are engaged with each other, the expanded shape of the side surface portion 220 of the barrel lid 200 can be returned to the original shape.

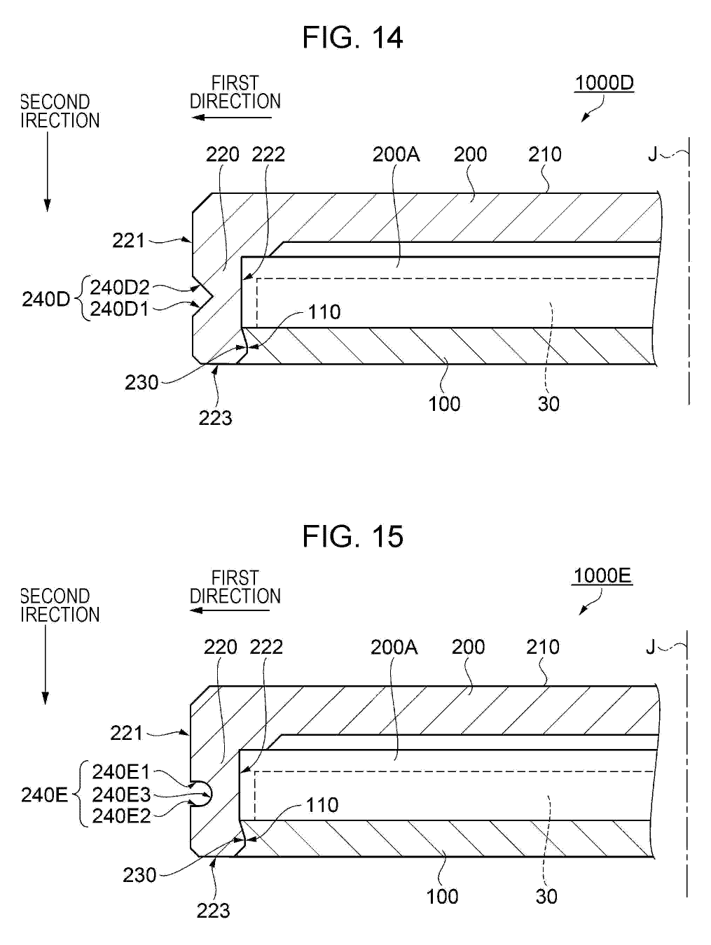

Further, the shape of the first groove 240 may be a shape as shown in FIG. 14. As shown in FIG. 14, in the barrel complete 1000D of Modified Example 4, the shape of the first groove 240D is formed in a V shape when the cross section of the side surface portion 220 including the rotary axis J is viewed. Specifically, the first groove 240D includes a first inclined portion 240D1 that is inclined toward a side of the flat surface portion 210 with respect to the outer surface 221 and extends toward a side of the inner surface 222, and a second inclined portion 240D2 that is inclined toward a side opposite to the side of the flat surface portion 210 with respect to the outer surface 221, extends toward the side of the inner surface 222, and is connected to the first inclined portion 240D1.

In this way, since the first groove 240D is formed in a V shape, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by deforming a thinned side surface portion 220. Accordingly, when the first engaging portion 110 and the second engaging portion 230 are engaged with each other, the expanded shape of the side surface portion 220 of the barrel lid 200 can be returned to the original shape.

Further, the shape of the first groove 240 may be a shape as shown in FIG. 15. As shown in FIG. 15, in the barrel complete 1000E of Modified Example 5, the shape of the first groove 240E is formed in a U shape when the cross section of the side surface portion 220 including the rotary axis J is viewed. Specifically, the first groove 240E includes a first extending portion 240E1 that extends from the outer surface 221 toward the inner surface 222, a second extending portion 240E2 that extends from the outer surface 221 toward the inner surface 222, and an arc portion 240E3 that connects the first extending portion 240E1 and the second extending portion 240E2 and includes an arc shape. The arc is not limited to an arc of a perfect circle, and may be an arc that is not a perfect circle.

In this way, since the first groove 240E is formed in a U shape, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by dispersing the force by the surface of a thinned side surface portion 220. Accordingly, when the first engaging portion 110 and the second engaging portion 230 are engaged with each other, the expanded shape of the side surface portion 220 of the barrel lid 200 can be returned to the original shape.

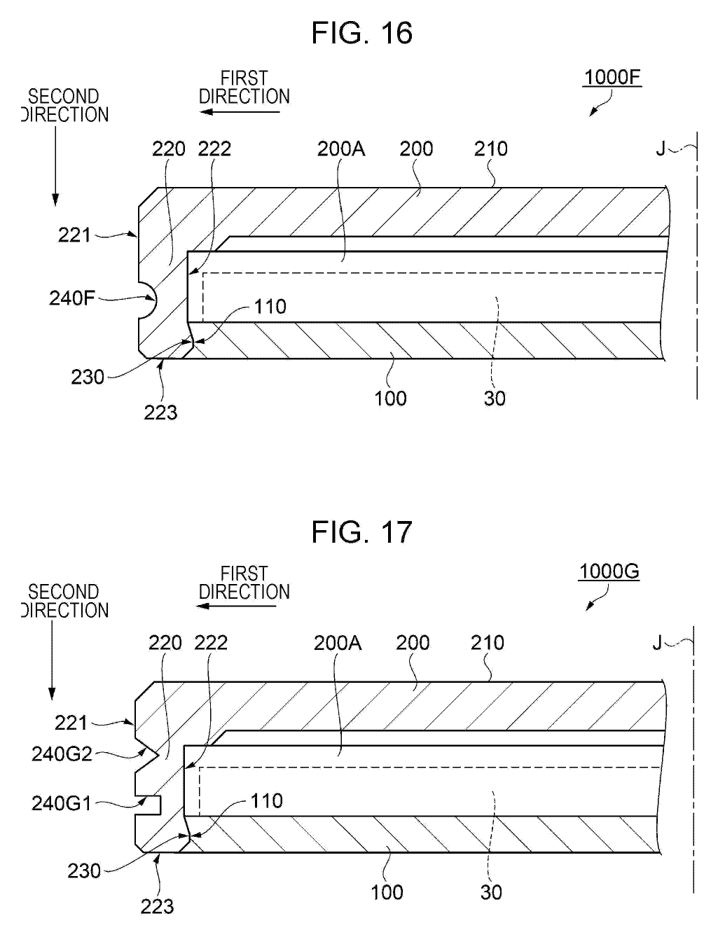

Further, the shape of the first groove 240 may be a shape as shown in FIG. 16. As shown in FIG. 16, in the barrel complete 1000F of Modified Example 6, the shape of the first groove 240F has an arc shape that opens to a side of the outer surface 221 side when the cross section of the side surface portion 220 including the rotary axis J is viewed. The arc is not limited to a circular arc of a perfect circle, and may be an arc that is not a perfect circle.

In this way, since the first groove 240F is formed in an arc shape, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by dispersing the force by the surface of a thinned side surface portion 220. Accordingly, when the first engaging portion 110 and the second engaging portion 230 are engaged with each other, the expanded shape of the side surface portion 220 of the barrel lid 200 can be returned to the original shape.

Further, the shape of the first groove 240 may be a shape as shown in FIG. 17. As shown in FIG. 17, in the barrel complete 1000G of Modified Example 7, a first groove 240G1 and a second groove 240G2 are formed on the side surface portion 220 when the cross section of the side surface portion 220 including the rotary axis J is viewed. In Modified Example 7, the first groove 240G1 is formed, for example, in a quadrangular shape. The second groove 240G2 is formed, for example, in a V shape. The shapes of the first groove 240G1 and the second groove 240G2 may be a combination of any shapes of the first grooves 240, 240A, 240C to 240F described above. In addition, the first groove 240B in which a rectangular shape is formed from the distal end surface 223 of the side surface portion 220 toward the thrust direction may be combined. Further, the number of grooves is not limited to two grooves 240G1 and 240G2, and three or more grooves may be formed.

In this way, since the first groove 240G1 and the second groove 240G2 are formed on the side surface portion 220, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by dispersing the pressure by the two grooves 240G1 and 240G2. Accordingly, when the first engaging portion 110 and the second engaging portion 230 are engaged with each other, the expanded shape of the side surface portion 220 of the barrel lid 200 can be returned to the original shape.

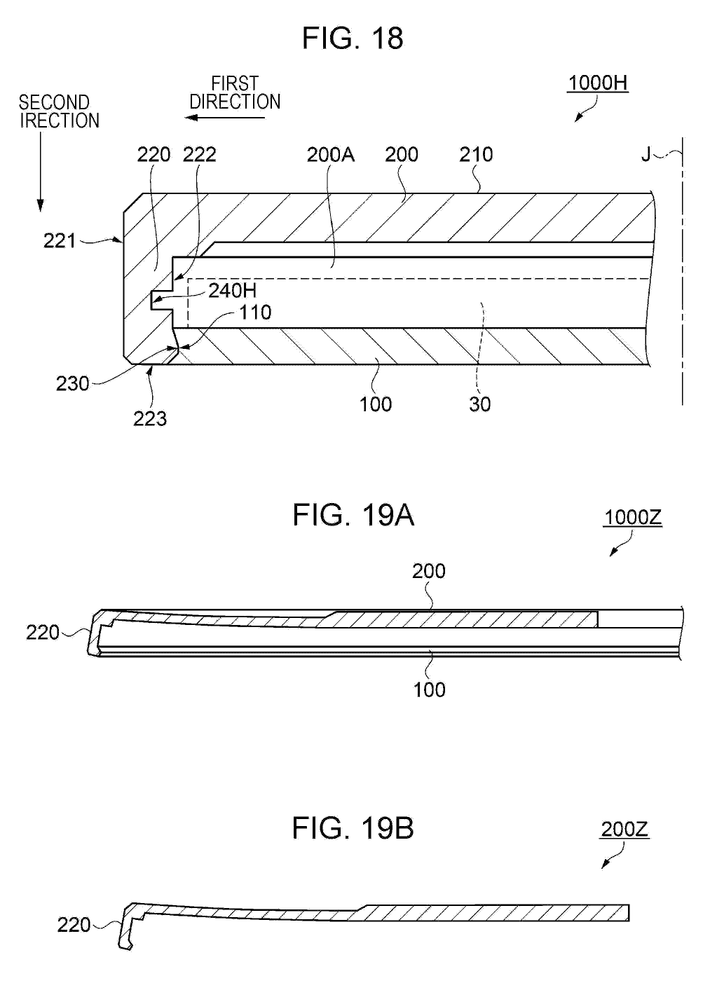

Further, the shape of the first groove 240 may be a shape as shown in FIG. 18. As shown in FIG. 18, in the barrel complete 1000H of Modified Example 8, the first groove 240H is provided on the inner surface 222 of the side surface portion 220 when the cross section of the side surface portion 220 including the rotary axis J is viewed. Specifically, the first groove 240H extends in a quadrangular shape from the inner surface 222 toward the outer surface 221 in the side surface portion 220. The shape of the first groove 240H may be any of the shapes of the first grooves 240, 240C to 240F described above.

In this way, since the first groove 240H is formed on the inner surface 222 of the side surface portion 220, a part of the side surface portion 220 can be thinned, and the rigidity of the side surface portion 220 can be weakened. Therefore, at the time of assembly, the stress applied to the side surface portion 220 around the second engaging portion 230, specifically, the pressure applied from the inner surface 222 to the outer surface 221 in the side surface portion 220, can be relieved by dispersing the pressure by a thinned side surface portion 220. Accordingly, when the first engaging portion 110 and the second engaging portion 230 are engaged with each other, the expanded shape of the side surface portion 220 of the barrel lid 200 can be returned to the original shape.

In addition, as described above, the first groove 240 is not limited to being formed in the entire circumference of the side surface portion 220 of the barrel lid 200, and the first groove 240 may be formed to be partially interrupted. The same applies to the second groove 240G2.

As described above, the second barrel complete 31 has been described as the barrel complete 1000 of the present embodiment, but the present disclosure is not limited thereto, and the first barrel complete 21 may be the barrel complete 1000.

As described above, the first engaging portion 110 has been described as the concave portion and the second engaging portion 230 has been described as the convex portion, but the present disclosure is not limited thereto. The first engaging portion 110 may be a convex portion and the second engaging portion 230 may be a concave portion, and the first engaging portion 110 and the second engaging portion 230 can adopt various structures as long as such structures allow the barrel lid 200 to be fixed to the barrel 100.

1. A barrel complete that rotates using a mainspring as a power source, the barrel complete comprising:
a barrel arbor having a rotary axis;
a barrel accommodating the mainspring; and
a barrel lid that is attached to the barrel and forms an accommodation space in which the mainspring is accommodated, wherein
the barrel lid includes:
a flat surface portion that extends along a first direction intersecting an axial direction along the rotary axis; and
a side surface portion that extends from an end portion of the flat surface portion along a second direction intersecting the first direction,
the side surface portion includes a second engaging portion that fixes the barrel lid to the barrel by being engaged with a first engaging portion formed on the barrel, and
a first groove that relieves stress is formed on the side surface portion.

2. The barrel complete according to claim 1, wherein
the first groove is provided on a distal end surface of the side surface portion, and extends from the distal end surface toward the flat surface portion in parallel to the rotary axis when a cross section of the side surface portion including the rotary axis is viewed.

3. The barrel complete according to claim 1, wherein
the first groove is provided on an inner surface of the side surface portion, and extends from the inner surface toward an outer surface of the side surface portion when a cross section of the side surface portion including the rotary axis is viewed.

4. The barrel complete according to claim 1, wherein
the first groove is provided on an outer surface of the side surface portion, and extends from the outer surface toward an inner surface of the side surface portion when a cross section of the side surface portion including the rotary axis is viewed.

5. The barrel complete according to claim 4, wherein
when the cross section is viewed, the first groove includes:
a first inclined portion that is inclined toward a side of the flat surface portion with respect to the outer surface, and extends toward a side of the inner surface;
a second inclined portion that is inclined toward a side opposite to the side of the flat surface portion with respect to the outer surface, and extends toward the side of the inner surface; and
a bottom portion that connects the first inclined portion and the second inclined portion.

6. The barrel complete according to claim 4, wherein
when the cross section is viewed, the first groove is inclined with respect to the outer surface, and extends toward a side opposite to the side of the flat surface portion.

7. The barrel complete according to claim 4, wherein
when the cross section is viewed, the first groove includes:
a first inclined portion that is inclined toward a side of the flat surface portion with respect to the outer surface, the first inclined portion extending toward a side of the inner surface; and
a second inclined portion that is inclined toward a side opposite to the side of the flat surface portion with respect to the outer surface, the second inclined portion extending toward the side of the inner surface and being connected to the first inclined portion.

8. The barrel complete according to claim 4, wherein
the first groove has an arc shape that opens to a side of the outer surface when the cross section is viewed.

9. The barrel complete according to claim 4, wherein
when the cross section is viewed, the first groove includes:
a first extending portion that extends from the outer surface toward a side of the inner surface;
a second extending portion that extends from the outer surface toward the side of the inner surface; and
an arc portion that connects the first extending portion and the second extending portion, and includes an arc shape.

10. The barrel complete according to claim 4, wherein
a second groove is formed on the side surface portion at a position different from a position where the first groove is formed.

11. A movement comprising:
the barrel complete according to claim 1;
a train wheel driven by the barrel complete;
a main plate on which the barrel complete is disposed; and
a train wheel bridge that supports the barrel complete and the train wheel together with the main plate.

12. A timepiece comprising:
the movement according to claim 11; and
a case that accommodates the movement.
